(19) United States
(12) Patent Application Publication
(10) Pub. No.: US 2008/0315058 A1
(43) Pub. Date: Dec. 25, 2008

(54) Adjustable Telescopic Support

(76) Inventor: Stelvio Zarpellon, Bassano Del Grappa (IT)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(21) Appl. No.: 12/087,044

(22) PCT Filed: Nov. 20, 2006
(86) PCT No.: PCT/EP2006/011094

§ 371 Date: Jun. 24, 2008

(30) Foreign Application Priority Data
Dec. 28, 2005 (IT) PD2005A000381

(51) Int. Cl. F16M 11/28

(52) U.S. Cl. 248/410; 248/411

(57) ABSTRACT

An adjustable telescopic support. The support has at least two tubular elements slidable telescopically one inside the other. A device locks the elements in an adjustable position and includes a seat at one end of the external tubular element and a contractible collar mounted in the seat between an operative position in which the collar is clamped on the internal tubular element and locks the tubular elements axially relative to each other, and a non-operative position in which the tubular elements can slide. A clamp is provided between the collar and the seat for contracting the collar as the collar moves in the seat. The support also has an actuator between the collar and the external tubular element that moves the collar axially in the seat between the operative and non-operative positions. The actuator includes a spring, a collar-carrying member, and a cam profile.

### RELATED APPLICATION

This application is a U.S. national phase application of International Patent Application No. PCT/EP2006/011094 filed on Nov. 20, 2006.

### TECHNICAL FIELD OF THE INVENTION

The present invention relates generally to an adjustable telescopic support and, more particularly but not exclusively, to a device for supporting video and photographic equipment.

### BACKGROUND ART

In the construction of supports for photographic equipment, such as monopods or tripods having telescopic legs, it is desired that the legs (and/or the central column of the support) should be telescopically adjustable without offering substantial resistance in the lengthening direction but should be subject to automatic locking, which can be released manually, in the opposite direction, that is to say, that of contraction. In practice, it would be desirable for the operator to be able to position the tripod with minimum force, even with one hand, and for the legs to lock automatically under the load they support.

A support of that type is known, for example, from U.S. Pat. No. 5,575,448 which is commonly owned by the assignee of the subject application.

The support described in that document is provided with a locking device which comprises a beaker-like formation fitted to one of the tubular elements, with a tapered seat in which are engaged two limbs projecting from a contractible collar capable of being clamped on the other tubular element in order to be locked thereon in a loading direction and to be unlocked in the opposite direction.

That device achieves the desired result of automatic locking of the telescopic elements in the loading direction but does have some disadvantages. A first disadvantage is caused by the decidedly large space requirement of the device which, especially in a photographic tripod, is hardly consistent with the requirements of compactness typical of the sector. A second disadvantage is caused by the complicated nature of the system for manually unlocking the device when it is desired to contract the telescopic rod to which it is fitted.

### SUMMARY OF THE INVENTION

The technical problem underlying the present invention is that of providing an adjustable telescopic support which is designed structurally and functionally to enable all of the disadvantages discussed with reference to the mentioned art to be overcome.

In the context of this problem, an important object of the invention is to provide a support, the locking device of which is suitable for being fitted on tubular elements produced from various materials. Another object of the invention is to provide a support which can be readily operated with one hand.

The identified problem is solved and these and other objects are achieved with an adjustable telescopic support according to the present invention. The support of the present invention has at least two tubular elements slidable telescopically one inside the other. A device locks the elements in an adjustable position and includes a seat at one end of the external tubular element, a contractible collar which is mounted in the seat, surrounds the internal tubular element and is axially mobile in the seat between an operative position in which the collar is clamped on the internal tubular element and placed in the seat, locking the tubular elements axially relative to each other, and a non-operative position in which the tubular elements are telescopically slidable with respect to each other. A clamp is provided between the collar and the seat for contracting the collar as a function of a movement thereof in the seat, the clamp including respective tapered profiles on the collar and/or on the seat which are such as to contract the collar in order to lock the tubular elements with respect to each other by the effect of an axial movement of the collar into the operative position in the seat. The support also has an actuator active between the collar and the external tubular element in order to move the collar axially in the seat between the operative and non-operative positions. The actuator includes a spring which is active between the collar, by interposition of a collar-carrying member, and the external tubular element in order to urge the collar towards the operative position of placement in the seat and a cam profile between the collar-carrying member and the external tubular element capable of moving the collar axially with respect to the seat between the operative and non-operative positions.

It is to be understood that both the foregoing general description and the following detailed description are exemplary, but are not restrictive, of the invention.

### BRIEF DESCRIPTION OF THE DRAWINGS

The features and advantages of the invention will emerge more clearly from the detailed description of some preferred embodiments thereof which are illustrated by way of non-limiting example with reference to the appended drawings in which:

FIG. 1 is a view in longitudinal section of a first embodiment of a support according to the invention;

FIG. 2 is an exploded perspective view of the support of FIG. 1;

FIG. 3 is a sectioned view of a second embodiment of the support of this invention;

FIG. 4 is a sectioned view of a third embodiment of the support of this invention;

FIG. 5 is a sectioned view on an enlarged scale of the detail indicated by the arrow V of FIG. 4;

FIG. 6 is a partial sectioned view of a variant of the support of FIG. 4;

FIG. 7 is an exploded perspective view of a further embodiment of the invention;

FIG. 8 is a view in axial section of the embodiment of FIG. 7; and

FIG. 9 is a sectioned view taken on the line IX-IX of FIG. 8.

It is emphasized that, according to common practice, the various features of the drawing are not to scale. On the contrary, the dimensions of the various features are arbitrarily expanded or reduced for clarity.

### BEST MODES FOR CARRYING OUT THE INVENTION

In FIGS. 1 and 2, the reference numeral 1 indicates generally a portion of a support, such as a portion of a leg of a tripod or monopod for optical, photographic or video-photographic equipment. The support 1 can, however, equally well be used for other purposes.

The support comprises a first and a second tubular element 2, 3 which are internal and external, respectively, and which can be slid telescopically one inside the other.

The tubular elements 2, 3 are guided one inside the other and can be locked in any relative position by a locking device 5 fitted between them.

The locking device 5 comprises a first sleeve 6 fitted and locked by a portion 7 thereof on one end of the external tubular element 3 and having, on its inside, a frustoconical seat 8 on which a covering 9 is fitted and held in a suitable recess. A shoulder 10 abutted by the corresponding end of the tubular element 3 is formed between the seat 8 and the portion 7. The seat 8 is thus fitted on the tubular element 3 and may be produced, together with the sleeve 6, with a material which is the same as or different from the material of the tubular element 3.

On its outer surface, the sleeve 6 has an annular enlarged portion 11 on which a series of cam profiles 12 are formed, each having a ramp 13 terminated by a portion 14 which extends circumferentially.

A second sleeve 15 is fitted slidably on the first sleeve 6. The second sleeve 15 has, for each cam profile 12, a cam-follower appendage 16 projecting radially inwards and is acted on by a spring 17 which is active in the direction of arrow F in FIG. 1 between a shoulder 18 formed by the enlarged portion 11 and an annular plug 19 fitted on the second sleeve 15.

The second sleeve 15 also has, on the side remote from the plug 19, a collar 20 which is resiliently contractible owing to the provision of notches 21 and which is fitted on the internal tubular element 2 to surround it completely. The collar 20 is secured in abutment against the second sleeve 15 by a bayonet coupling 21a. The latter has, on the outside, a frustoconical shell surface 22 which engages in the seat 8 of the first sleeve 6 with the interposition of the covering 9. The covering 9 preferably has a coefficient of friction which is lower, with respect to the surface of the collar 20, than the coefficient of friction between the internal surface of the collar 20 and the external surface of the tubular element 2, so that the collar 20 can be moved with respect to the seat 8 more readily than with respect to the tubular element 2. The covering 9 is fitted on the seat 8 in the form of a frustoconical ring composed of a sheet-form plastic material having a low coefficient of friction.

The second sleeve 15 can be rotated manually with respect to the first sleeve 6 in order to move the cam-follower appendages 16 between the circumferential portion 14, in which the collar 20 is locked with respect to the seat 8 in a non-operative position in which the tubular elements 2, 3 are free to slide with respect to each other, and the ramp 13, in which the collar 20 is urged by the spring 17 into an operative position in the seat 8 in order to lock the tubular elements 2, 3 with respect to each other. The spring 17, the cam profiles 12 and the cam-follower appendages 16 therefore constitute an actuator between the second sleeve 15 and the external tubular element 3 in order to move the collar 20, by the second sleeve 15, between the operative and non-operative positions identified above. It should be mentioned that, in that position, a load acting in the direction tending to insert the first tubular element 2 more deeply into the second tubular element 3 tends to drive the collar 20 further into the seat 8, increasing the resilient contraction of the collar 20 and the resulting locking force in respect of the tubular elements 2, 3. Conversely, an urging in the opposite direction tends to move the collar 20 axially with respect to the seat 8 in the direction of compression of the spring 17, thus freeing the relative sliding between the tubular elements 2, 3.

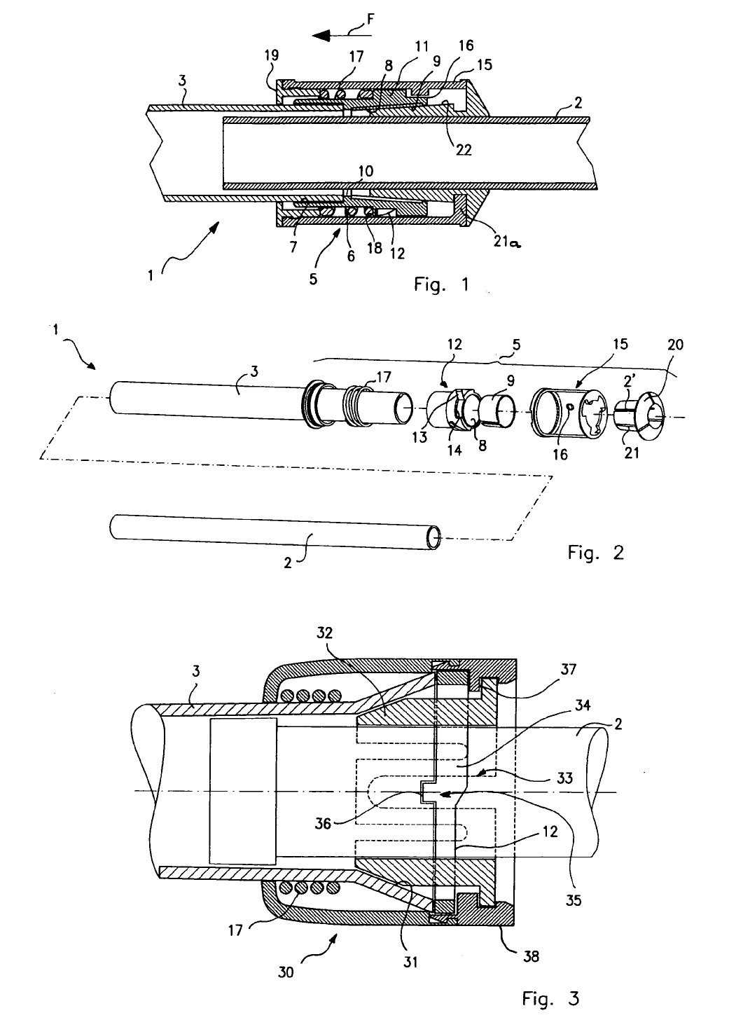

Referring now to FIG. 3, a second embodiment of the support of the present invention is generally indicated by the reference numeral 30. Details analogous to those just described are indicated by the same reference numerals.

In this embodiment of support 30, the seat 31 for accommodating the contractible collar 32 is formed by flaring at the corresponding end of the external tubular element 3. It will be appreciated that the material of the seat 31 and the material of the external tubular element 3 are in that case identical.

The cam profile 12 in this case comprises a front cam 33 formed at the corresponding end of the external tubular element 3 by fitting an annular element 34 to the mouth of the seat 31. The annular element 34 is locked against rotation on the external tubular element 3 by the engagement of a tooth 35 in a corresponding recess 36. One (or more) projection(s) 37 from the second sleeve 38 is (are) provided as (a) cam-follower appendage(s).

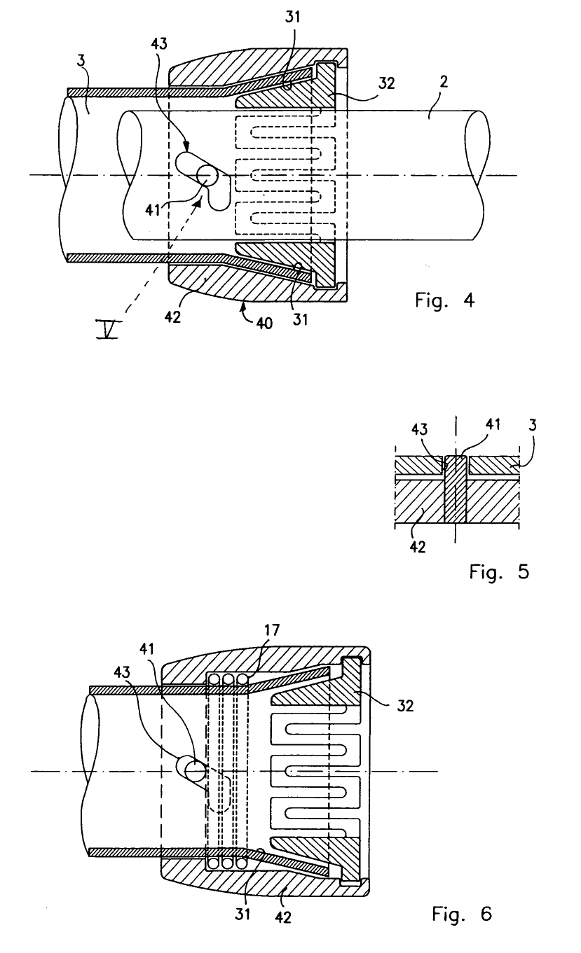

In the embodiment of FIG. 4, in which the support is generally indicated by the reference numeral 40, the cam-follower appendage is formed by a peg 41 placed radially in the sleeve 42 and projecting inside the same in such a manner as to engage a cam profile 43 formed by producing a slot in the external tubular element 3. The sleeve 42 may (FIG. 6) or may not (FIG. 5) be provided with a spring 17 so that the cam and the cam-follower can, if necessary, be the only mechanism actuating the locking device. In this case too, as in the remaining embodiments, details analogous to those of the previous Figures are marked by the same reference numerals.

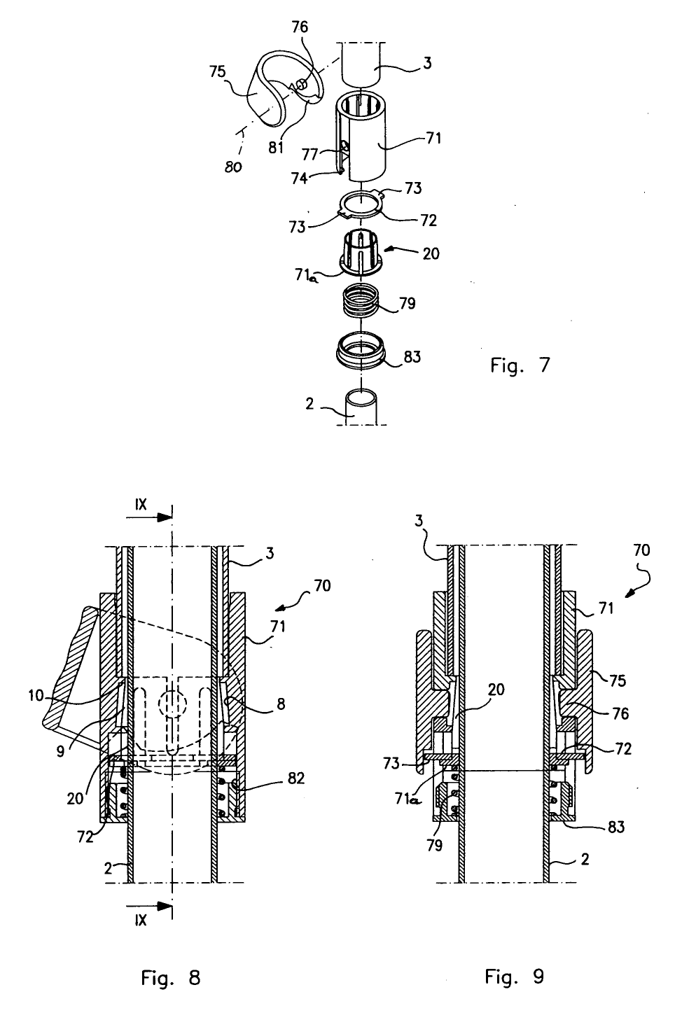

With reference to FIGS. 7 to 9, a further embodiment of the support of the present invention is generally indicated by the reference numeral 70.

A sleeve 71 is fitted and secured to the external tubular element 3 in a manner completely analogous to the sleeve 6 of the first embodiment. Like the latter, the sleeve 71 has the seat 8, complete with the covering 9, and also the shoulder 10. Also completely the same except for structural details is the collar 20 which is terminated by a flange 71a abutted by a collar-carrying member in the form of an annular element 72 having two diametric appendages 73 projecting radially outwards and acting as cam-followers. The appendages 73 are accommodated in respective opposite openings 74 formed longitudinally in the sleeve 71. A tilting element 75 is pivoted about a transverse axis 80 by respective pins 76 in corresponding seats 77 formed in the sleeve 71 at the base of the openings 74. The collar 20 is moved in the seat 8 against the force of a spring 79 by cam profiles 81 with which the cam-follower appendages 73 cooperate and which are formed on the tilting element 75 that pivots about the transverse axis 80. The spring 79 tends to place the collar 20 in the seat 8 in an operative position of locking the tubular elements 2, 3 and it is held in a recess 82 of the sleeve 71 by a screw plug 83.

By pivoting the tilting element 75 about the axis 80, either the tubular elements 2, 3 are released, in order to adjust the relative extension thereof, when the cam profiles 81 act on the cam-follower appendages 73 in order to disengage the collar 20 from the seat 8, or they are locked, when the cam profiles 81 allow the spring 79 to place the collar 20 in the seat 8.

The invention thus solves the problem set and achieves numerous advantages over traditional supports. These include the compactness of the locking device between the tubular elements and the locking efficiency which is proportional to the load acting on the support. Another important advantage is the fact of being able to adapt the invention to supports whose telescopic tubular elements are constructed with various materials, which may or may not be suitable for undergoing flaring machining.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

1. An adjustable telescopic support comprising:
an external tubular element and an internal tubular element which are slidable telescopically one inside the other;
a device positioned between the internal and external tubular elements for locking the tubular elements in an adjustable position which includes a seat at one end of the external tubular element, a contractible collar which is mounted in the seat, surrounds the internal tubular element and is axially mobile in the seat between an operative position in which the collar is clamped on the internal tubular element and placed in the seat, locking the tubular elements axially relative to each other, and a non-operative position in which the tubular elements are telescopically slidable with respect to each other;
a clamp between the collar and the seat for contracting the collar as a function of a movement thereof in the seat, the clamp including respective tapered profiles on the collar and/or on the seat which are such as to contract the collar in order to lock the tubular elements with respect to each other by the effect of an axial movement of the collar into the operative position in the seat; and
an actuator active between the collars, by the interposition of a collar-carrying member on which the collar is mounted, and the external tubular element in order to move the collar axially in the seat between the operative and non-operative positions, the actuator comprising (a) a spring which is active between the collar and the external tubular element in order to urge the collar towards the operative position of placement in the seat,
and (b) a cam profile between the collar-carrying member and the external tubular element capable of moving the collar axially with respect to the seat between the operative and non-operative positions.

2. The adjustable telescopic support according to claim 1, wherein the cam profile comprises a circumferential cam formed on one of the collar-carrying member and the external tubular element, and a cam-follower formed on the other of the collar-carrying member and the external tubular element, the cam profile and the cam-follower being coupled to each other.

3. The adjustable telescopic support according to claim 1, wherein the seat is formed by flaring the corresponding end of the external tubular element.

4. The adjustable telescopic support according to claim 1, wherein the seat is provided on a first sleeve fitted on the external tubular element.

5. The adjustable telescopic support according to claim 4, wherein the collar-carrying member is in the form of a second sleeve surrounding the outside of the external tubular element.

6. The adjustable telescopic support according to claim 5, wherein the spring is fitted on the external tubular element, between the latter and the second sleeve.

7. The adjustable telescopic support according to claim 1, wherein the cam profile comprises a front cam formed at the corresponding end of the external tubular element.

8. The adjustable telescopic support according to claim 7, wherein the front cam is formed on an annular element fitted at the corresponding axial end of the external tubular element.

9. The adjustable telescopic support according to claim 8, wherein anti-rotation means are provided between the external tubular element and the annular element fitted thereon.

10. The adjustable telescopic support according to claim 1, wherein the interface surface between the seat and the collar has a coefficient of friction which is lower than that of the interface surface between the collar and the internal tubular element.

11. The adjustable telescopic support according to claim 1, wherein the cam profile is associated with a tilting element pivoted transversely on the external tubular element about a pivot axis, the collar-carrying member comprising at least one cam-follower appendage cooperating with the cam profile in order to move the collar against the force of the spring.

12. The adjustable telescopic support according to claim 11, wherein the tilting element is pivoted in respective pivot seats formed on a sleeve fitted on the external tubular element, an opening, through which the cam-follower appendage projects radially outwards, being provided proximate at least one of the seats, and the cam profile being formed on the tilting element.

13. The adjustable telescopic support according to claim 1, wherein the seat is formed from the same material as the external tubular element.

14. The adjustable telescopic support according to claim 10, wherein the interface surface between the seat and the collar is formed from plastic material.

15. An adjustable telescopic support comprising:
an external tubular element and an internal tubular element which are slidable telescopically one inside the other;
a device positioned between the internal and external tubular elements for locking the tubular elements in an adjustable position which includes a seat at one end of the external tubular element, a contractible collar which is mounted in the seat, surrounds the internal tubular element and is axially mobile in the seat between an operative position in which the collar is clamped on the internal tubular element and placed in the seat, locking the tubular elements axially relative to each other, and a non-operative position in which the tubular elements are telescopically slidable with respect to each other;
a clamp between the collar and the seat for contracting the collar as a function of a movement thereof in the seat, the clamp including respective tapered profiles on the collar and/or on the seat which are such as to contract the collar in order to lock the tubular elements with respect to each other by the effect of an axial movement of the collar into the operative position in the seat; and
an actuator active between the collar, by the interposition of a collar-carrying member on which the collar is mounted, and the external tubular element in order to move the collar axially in the seat between the operative and non-operative positions, the actuator comprising (a) a spring which is active between the collar and the external tubular element in order to urge the collar towards the operative position of placement in the seat, and (b) a cam profile between the collar-carrying member and the external tubular element capable of moving the collar axially with respect to the seat between the operative and non-operative positions, the cam profile including a circumferential cam formed on one of the collar-carrying member and the external tubular element and a cam-follower formed on the other of the collar-carrying member and the external tubular element, the cam profile and the cam-follower being coupled to each other,
wherein the interface surface between the seat and the collar has a coefficient of friction which is lower than that of the interface surface between the collar and the internal tubular element.

16. The adjustable telescopic support according to claim 15, wherein the seat is formed by flaring the corresponding end of the external tubular element.

17. The adjustable telescopic support according to claim 15, wherein the seat is provided on a first sleeve fitted on the external tubular element and the collar-carrying member is in the form of a second sleeve surrounding the outside of the external tubular element.

18. The adjustable telescopic support according to claim 17, wherein the spring is fitted on the external tubular element, between the latter and the second sleeve.

19. An adjustable telescopic support comprising:
an external tubular element and an internal tubular element which are slidable telescopically one inside the other;
a device positioned between the internal and external tubular elements for locking the tubular elements in an adjustable position which includes a seat at one end of the external tubular element, a contractible collar which is mounted in the seat, surrounds the internal tubular element and is axially mobile in the seat between an operative position in which the collar is clamped on the internal tubular element and placed in the seat, locking the tubular elements axially relative to each other, and a non-operative position in which the tubular elements are telescopically slidable with respect to each other;
a clamp between the collar and the seat for contracting the collar as a function of a movement thereof in the seat, the clamp including respective tapered profiles on the collar and/or on the seat which are such as to contract the collar in order to lock the tubular elements with respect to each other by the effect of an axial movement of the collar into the operative position in the seat; and
an actuator active between the collar, by the interposition of a collar-carrying member on which the collar is mounted, and the external tubular element in order to move the collar axially in the seat between the operative and non-operative positions, the actuator comprising (a) a spring which is active between the collar and the external tubular element in order to urge the collar towards the operative position of placement in the seat, and (b) a cam profile between the collar-carrying member and the external tubular element capable of moving the collar axially with respect to the seat between the operative and non-operative positions, the cam profile including a front cam formed on an annular element fitted at the corresponding axial end of the external tubular element,
wherein the interface surface between the seat and the collar has a coefficient of friction which is lower than that of the interface surface between the collar and the internal tubular element.

20. The adjustable telescopic support according to claim 19, wherein anti-rotation means are provided between the external tubular element and the annular element fitted thereon.
